(19) United States
(12) Patent Application Publication
(10) Pub. No.: US 2002/0083201 A1
(43) Pub. Date: Jun. 27, 2002

(54) Formatting and delivering arbitrary content to wireless handheld devices

(76) Inventors: Sridhar Iyengar, Portland, OR (US); David Sokolower, Bethesda, MD (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/746,684

(22) Filed: Dec. 22, 2000

(51) Int. Cl. G06F 15/16

(52) U.S. Cl. 709/246

(57) ABSTRACT

A wireless handheld device displays arbitrary interactive content using a local computer system as a front end processor for the interactive content. A user of the handheld indicates with the handheld device interest in obtaining a content catalog identifying interactive content available to the user. This interactive content is in a first data format provided by a content provider; the first data format may be incompatible with the handheld device, requiring it to be converted into a compatible second format. The user selects content in the content catalog having the first data format. The local computer system reformats the first data format into the compatible second data format. The handheld device then receives selected content in the second data format.

### FIELD OF THE INVENTION

The invention generally relates to viewing content with a wireless handheld device, and more particularly to viewing and interacting with content interactive content that is in a format incompatible with the handheld device, where an external system retrieves the incompatible content and converts it into compatible content.

### BACKGROUND

With the advent of fast and affordable networking equipment and Internet access, many new products have come to market that allow a consumer to augment everyday experiences with content obtained over a network. For example, for some television broadcasts, such as home shopping channels and game shows, the broadcaster may provide web sites containing content relevant to a particular show, item, or topic currently being broadcast to viewers. For example, QVC Inc. broadcasts items for display that may be purchased by a viewer having access to their Internet web site. Similarly, ABC's “Who Wants To Be A Millionaire” program simultaneously presents game show questions on an Internet web page so that viewers may play alongside contestants.

One attempt to provide web content along with a television broadcast is Microsoft's “webtv” product, which incorporates an Internet browser within a television set top box. (Please note that all marks used herein are the property of their respective owners.) Unfortunately, this integrated configuration, while convenient, presents several significant limitations. One limitation is that available screen real estate is limited if one combines display of television and interactive content. Alternatively, could elect whether to watch one or the other, but not both. Another limitation is that the content must be broadcast along with the viewing signal, e.g., over the cable television cable, which limits applicability of the product. Further, and more significantly, this solution requires usage of specialized hardware, e.g., inserters, encoders, decoders, processors, memory, etc., all of which significantly increases the cost of production for this solution.

A second attempt to provide contemporaneous interactive content is to simulcast interactive over the Internet. However, there are several significant problems with this solution. For example, this solution is not ergonomic, as it requires one to sit close to a personal computer display to receive the interactive content, and then look at a distance to the television. This is due to a computer typically being located remote to the television. Also, one's home computer typically is not even in the same room as the television, thus rendering this solution impractical as it requires one to leave the television viewing room to access the computer. Alternatively, one must install a computer system in the television viewing room, a solution many people would not like.

A third attempt at contemporaneous interactive content to provide, such as by way of an Internet simulcast, interactive content to wireless handheld computers, such as Microsoft Windows CE machines or Palm Computing's Personal Information Managers (PIMs) running AvantGo, Inc.'s AvantGo software, or equivalent. These machines operate using a microbrowser that receives the provided interactive content, and the handheld reformats received content for display on the handheld. Reformatting is necessary since general interactive content assumes a general computer system recipient, and not the limited capabilities of a handheld device. Unfortunately, ability to reformat content significantly increases the cost and complexity of the handheld device, as reformatting is nontrivial.

### BRIEF DESCRIPTION OF THE DRAWINGS

The features and advantages of the present invention will become apparent from the following detailed description of the present invention in which:

FIG. 1 illustrates an exemplary hardware environment according to one embodiment of the invention.

FIG. 2 illustrates an exemplary flow chart for retrieving interactive content for a handheld device while watching a television broadcast.

FIG. 3 illustrates a suitable computing environment in which certain aspects of the invention may be implemented.

### DETAILED DESCRIPTION

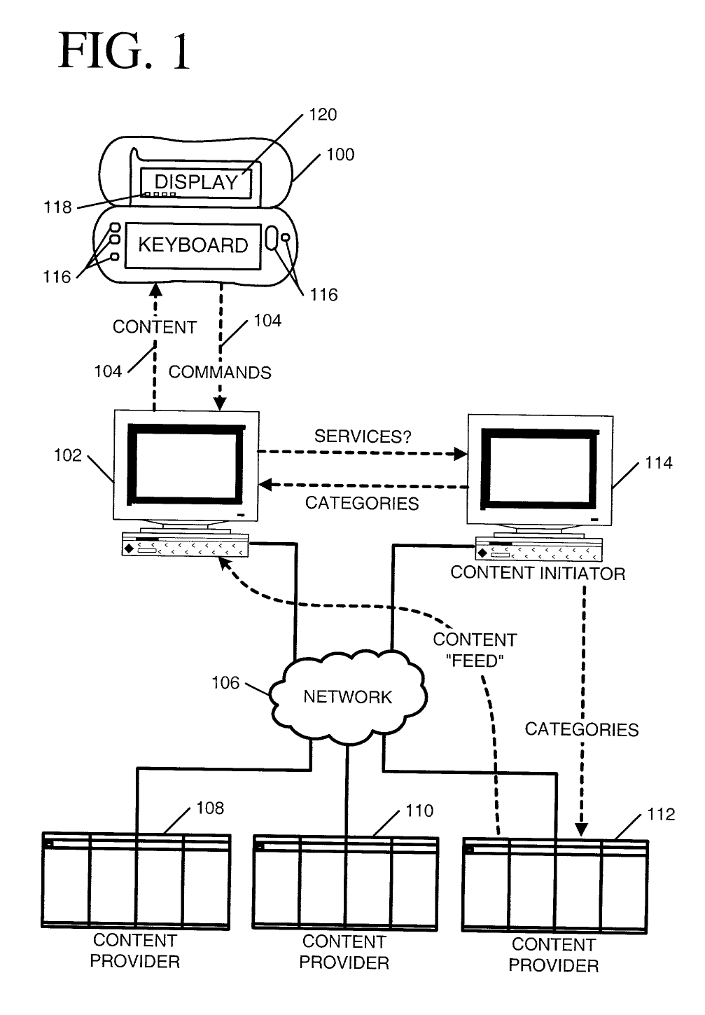

FIG. 1 illustrates an exemplary hardware environment according to one embodiment of the invention.

A wireless handheld device 100 is in communication with a local computer system 102, such as a home personal computer (PC). The handheld device communicates with the local computer system 102 over a wireless channel 104, such as a radio frequency (RF), infrared (IR), or other wireless channel, using a communication protocol such as (IEEE) 802.11 or other protocol. Various wireless transmission strategies may be used to convey data to the handheld device. For example, wireless communications may use direct or diffuse IR, narrowband RF transmissions, 900 MHz or 2.4 GHz transmissions, spread spectrum RF technology such as frequency hopping or direct sequence, etc. It is intended that any wireless communication channel and communication protocol may be used to implement wireless channel 104.

The local computer system 102 acts as a computation engine to format incoming content, and it operates as a shared connection point to a network 106 and a storage device to cache additional content for the handheld device. In contrast with current handheld devices that are required to reformat interactive content to conform the content to the capabilities of the handheld device, in one embodiment, the power of the local computer system 102 is instead leveraged to perform this function. This allows the construction of the handheld device to be simplified, thus reducing manufacturing costs and risk of failure, e.g., less complex design leaves fewer elements to break. In the claims that follow, the phrases “formatting agent” and “formatting server” refer to a local computer system and/or an application program that converts content for use by the handheld device. A formatting agent/server may also act as a storage agent or cache for content, and as a network access point for multiple handheld devices.

In this embodiment, the handheld device is required only to support a single content format environment, e.g., a single environment or operating system for receiving user input and displaying output; in another embodiment, the handheld device supports a restricted number of content format environments. The local computer system 102 is responsible for retrieving interactive content, which may be in any arbitrary format, such as Internet formats (e.g., HyperText Markup Language (HTML), Dynamic HTML (DHTML), Java, JavaScript, ActiveX), Standard formats (e.g., Extensible Markup Language (XML), Advanced Television Enhancement Forum (ATVEF), etc.), or a proprietary format (e.g. Sports tickers, etc.), and then converting the arbitrary format as required into the handheld device's supported environment. In one embodiment, the handheld local data format is the Wireless Application Protocol (WAP) Wireless Markup Language (WML) (a variant on XML designed for portable devices).

It will be appreciated that some interactive content may be active or dynamic, e.g., making use of Java, Javascript, etc. In such cases, the local computer system 102 executes the active or dynamic content and provides resultant data (e.g., output) to the handheld device. In effect, the local computer system acts as a simple input/output device, where the handheld controls the local computer system. User input to the handheld is transmitted to the local computer system and used to control the active or dynamic content executing thereon, and results from such indirect user control of the local computer system is converted and sent back to the handheld device. In one embodiment, electronic mail (E-mail) services are provided to the handheld device.

The local computer system 102 is communicatively coupled to a network 106, such as an intranet or Internet. In one embodiment, the local computer system retrieves networked resources from remote content providers 108, 110, 112. For example, such providers may offer games, news, shopping, etc., that are tied in or synchronized with television broadcasts, live sporting events, or other viewer experiences. It will be appreciated that any number of conventional wireless and wired techniques may be used to connect the local computer system to the network 106, and that various networks may be used to communicate with content providers. As discussed above, the handheld device receives data from the local computer system 102 over wireless channel 104; however, note that the wireless channel may be carried, in part, over network 106. For example, a wireless base station (not illustrated) may be in communication with the local computer system 102 over the network 106. Thus, communication from the local computer system is sent over the network 106, to the base station, which in turn wirelessly communicates with the handheld device 100.

The local computer system 102 is also communicatively coupled to a content initiator 114. Unlike the local computer system, the content initiator is likely physically remote from the local computer system and handheld device, and may also be communicatively coupled to the network 106. When a user of the handheld desires to engage in entertainment augmentation services, the content initiator is responsible for providing the local computer system with a catalog of services currently available to the user. The catalog of services corresponds to various interactive content that may be retrieved by the local computer system for conversion and provision to the handheld device. It will be appreciated that various known techniques can be used to ensure a local computer system is presented with a catalog that “makes sense” with respect to the location of the handheld device. For example, different geographic time zones are frequently provided with different television broadcasts, thus it may be necessary to ensure that the catalog is specific to a particular handheld device's location.

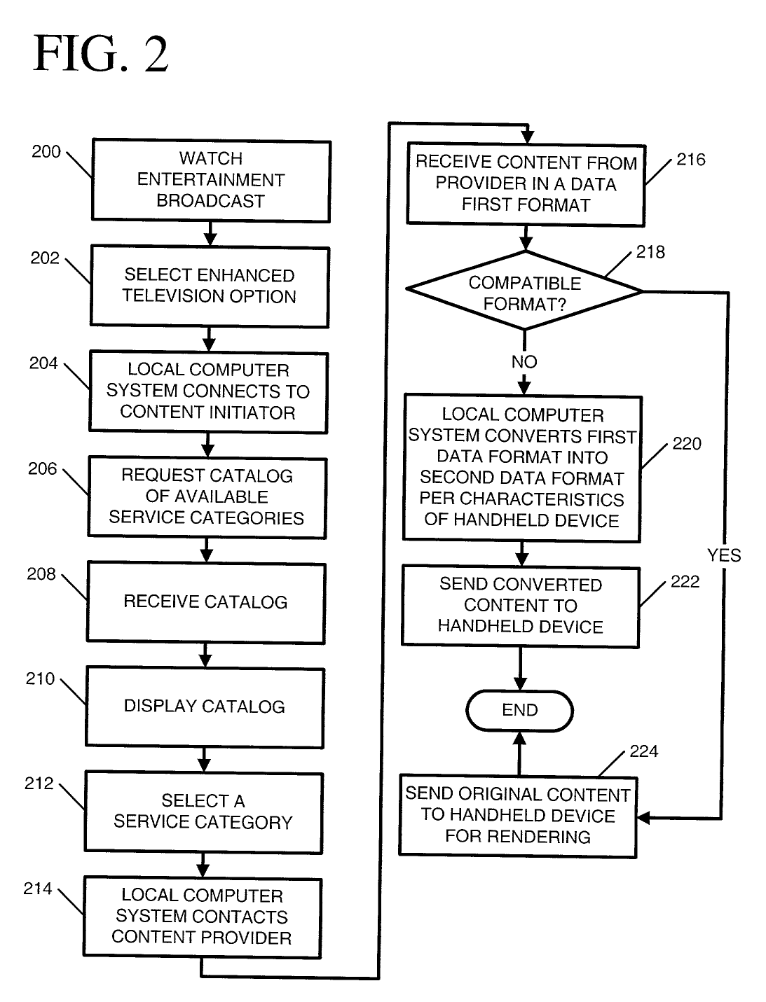

FIG. 2 illustrates an exemplary flow chart for retrieving interactive content for a handheld device while watching a television broadcast.

A first operation is to watch 200 an entertainment broadcast, e.g., a television broadcast, such as a traditional terrestrial, satellite or cable broadcast, or a broadcast through a physical medium such as an intranet or Internet network. It will be appreciated that the illustrated flowchart applies to using the handheld device in other contexts besides augmenting television viewing. During watching, a user of the handheld device selects 202 a button, such as a physical button 116 (FIG. 1) within the casing of the handheld device, or a logical button 118 drawn on the display 120 of the handheld device. This selection may occur irrespective of whether the user is watching television.

The illustrated embodiment assumes a television broadcast context, hence selection 202 of the button indicates the user wants to engage in entertainment augmentation, e.g., enhanced television making use of interactive content related to the watched 200 broadcast. In one embodiment, the handheld device and television are completely decoupled, e.g., the television broadcast and providing of interactive content are entirely separate. Thus, the television may be an ordinary television receiving a signal from any source, such as an aerial antenna. In this embodiment, interactive content is simply provided contemporaneous to the television broadcast. The degree of synchronization between interactive content and the broadcast may be determined at the broadcast head end. In another embodiment, the content is embedded within the television signal, and extracted for conversion and presentation to the handheld device.

In response to selecting the button 116, 118, the handheld device, by way of the local computing device 102, transparently connects 204 to a content initiator 114. The content initiator may be operated by an entity that assembles various interactive content for delivery to requesting local computer systems 102. In one embodiment, there are multiple content initiators each providing different content arrangements to local computer systems for delivery to handheld devices. The handheld device requests 206 a catalog of available services from the content initiator. The content initiator is responsible for assembling data to store in the catalog. This data may be retrieved by the content initiator through contacting content providers 108, 110, 112, and polling them for data, or by having catalog data pushed to the content initiator.

In response to the request 206, the handheld device receives 208 the catalog over the wireless link 104. The catalog is displayed 210 on the handheld device display 120, and a user selects 212 a desired content category, e.g., Sports broadcast, Electronic Program Guide (EPG), entertainment TV shows. In one embodiment, catalog content categories comprise links to content provider 108, 110, 112 content (e.g., television guides, interactive entertainment, order processing systems, etc.), and selection 212 of a category directs the local computer system 102 to contact 214 the appropriate linked content provider.

In response to contacting a linked content provider 108, 110, 112, the local computer system receives 216 content “feed” from the linked content provider in a first data format, e.g., HTML, DHTML, XML, Java code, etc. In one embodiment, the local computer system tests 218 whether this first data format is compatible with the handheld device, e.g., can the content be directly forwarded to the handheld device for appropriate processing.

If the first data format is incompatible with the handheld device, the processing power of the local computer system 102 is utilized to convert 220 the first data format into a second data format that is compatible with the handheld device, e.g., the local computer system acts as a formatting agent for the handheld device. For example, in one embodiment, the handheld device is configured to process WML encoded data. When the first data format is non-WML interactive content, the local computer system converts it into the compatible second data format WML content.

In another embodiment, conversion is based on handheld device characteristics. Thus, if the handheld device has limited memory, content images may be deleted, reduced in size, replaced with placeholders, or streamed to the handheld for scrolling across the screen as necessary. (For scrolling an image past the display, no storage is required beyond display needs since the image is not stored on the handheld device.) If the handheld device has a non-color display, color data may be removed from content. If the content includes forms or other web page data, these forms and other data can be converted and re-formatted, if necessary, to best-fit the handheld device display.

In another embodiment, the storage capacity of the local computer system 102 is used to cache content received from the network. This cached data may be displayed on the handheld device. An exemplary use for cached data is caching a weekly download of an Electronic Program Guide (EPG). The EPG is likely to be accessed frequently, and caching the guide allows it to be displayed quickly, and also allows it to be displayed without use of a network connection.

Once the first data format is converted 220 into the second data format, it is sent 222 to the handheld device for processing. If 218 the content was originally compatible, as may be found, for example, at select sites directly supporting the handheld device, then the original content is sent 224 to the handheld device for processing.

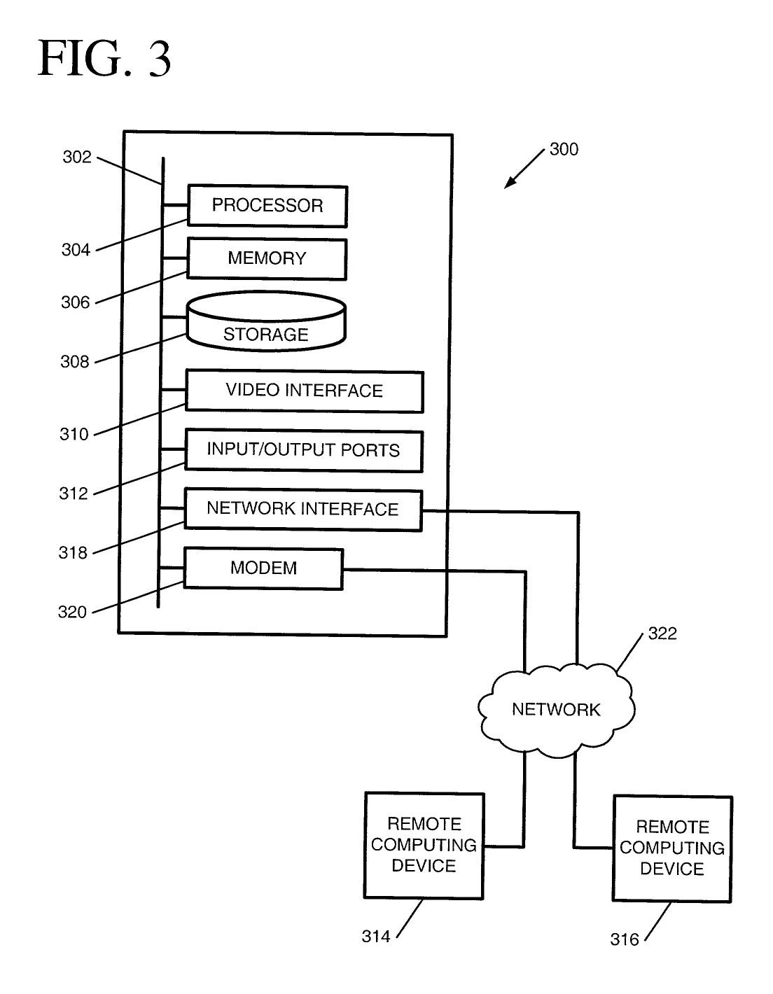

FIG. 3 and the following discussion are intended to provide a brief, general description of a suitable computing environment in which certain aspects of the illustrated invention may be implemented.

An exemplary system for implementing the invention includes a computing device 300 having system bus 302 for coupling various computing device components. This system, or portions thereof, may be used to implement the FIG. 1 handheld device 100, local computer system 102, content providers 108-112, and content initiator 114. Typically, attached to the bus are non-programmable and programmable processors 304, a memory 306 (e.g., RAM, ROM), storage devices 308, a video interface 310, and input/output interface ports 312. Storage devices include hard-drives, floppy-disks, optical storage, magnetic cassettes, tapes, flash memory cards, memory sticks, digital video disks, and the like.

Portions of the invention may be described by reference to different high-level program modules and/or low-level hardware contexts. Those skilled in the art will realize that program modules can be interchanged with low-level hardware instructions. Program modules include procedures, functions, programs, components, data structures, and the like, for performing particular tasks or implementing particular abstract data types. Modules may be incorporated into single and multi-processor computing devices, such as the local computer system, content providers, content initiators, handheld devices such as the device illustrated in FIG. 1, Personal Digital Assistants (PDAs), cellular telephones, and the like. Thus, the storage systems and associated media can store data and executable instructions for the computing device. Modules may be implemented within a single computing device, or processed in a distributed network environment, and stored in both local and/or remote memory.

The computing device is expected to operate in a networked environment using logical connections to one or more remote computing devices 314, 316 through a wired or wireless network interface 318, modem 320, or other communication pathway. Computing devices may be interconnected by way of a network 322 such as an intranet, the Internet, or other network. This network may be, in whole or in part, the FIG. 1 network 106. Thus, for example, with respect to the illustrated embodiments, assuming computing device 300 is the handheld device 100, then by way of the local computer system 102, remote devices 314, 316 may respectively be the content initiator 114 and a content provider 108, 110, 112. The FIG. 1 handheld device 100, by way of the local computer system 102, may receive content catalogs and content provider 108-112 content distributed over the network 322.

It will be appreciated that remote computing devices 314, 316 may be configured like computing device 300, and therefore include many or all of the elements discussed for computing device. It should also be appreciated that computing devices may be embodied within a single device, or separate communicatively-coupled components, and may include or be embodied within routers, bridges, peer devices, web servers, and application programs utilizing network application protocols such as the HyperText Transfer Protocol (HTTP), File Transfer Protocol (FTP), and the like.

Having described and illustrated the principles of the invention with reference to illustrated embodiments, it will be recognized that the illustrated embodiments can be modified in arrangement and detail without departing from such principles.

And, even though the foregoing discussion has focused on particular embodiments, it is understood that other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments, and unless implicitly or expressly indicated otherwise, embodiments are combinable into other embodiments. Consequently, in view of the wide variety of permutations to the above-described embodiments, the detailed description is intended to be illustrative only, and should not be taken as limiting the scope of the invention.

What is claimed as the invention, therefore, is all such modifications as may come within the scope and spirit of the following claims and equivalents thereto.

What is claimed is:

1. A method for a handheld device to facilitate interaction with a viewing device receiving a broadcast, comprising:
indicating with the handheld device interest in obtaining a content catalog identifying content in a first data format provided by a content provider;
receiving the content catalog from a formatting agent;
selecting content in the content catalog having the first data format; and
receiving said selected content from the formatting agent in a second data format compatible with the handheld device.

2. The method of claim 1, wherein the handheld device comprises a wireless coupling to the formatting agent.

3. The method of claim 1, wherein the content catalog content corresponds at least in part to broadcasts available for receipt by the viewing device.

4. The method of claim 1, further comprising:
broadcasting the broadcast to the viewing device over a communication channel;
determining broadcast-related data for the broadcast; and
making said broadcast-related data available to a content initiator so that the content initiator associates said broadcast related data with the content catalog.

5. The method of claim 4, further comprising:
providing, by a broadcaster, said broadcast-related data to a content provider so that the content provider makes said broadcast-related data available to the content initiator.

6. The method of claim 1, wherein the first data format is incompatible with the handheld device, the method further comprising:
retrieving said selected content from the content provider;
converting the first data format into the second data format;
transmitting the second data format to the handheld device; and
rendering the second data format on the handheld device.

7. The method of claim 1, further comprising:
retrieving by the formatting agent of said selected content from the content provider;
determining the first data format is incompatible with the handheld device; and
converting said selected content into said compatible second data format.

8. The method of claim 7, wherein said converting comprises:
determining characteristics of the handheld device;
identifying a portion of said selected content that is incompatible with the handheld device; and
converting said incompatible portion into a compatible portion based on said determined characteristics.

9. The method of claim 7, wherein said incompatible portion comprises an Internet communication protocol.

10. The method If claim 1, wherein the content catalog comprises selected ones of: links to content provider content, and embedded content provider content.

11. An apparatus, comprising a machine accessible medium having instructions encoded therein, which when executed by the machine, are capable of directing the machine to perform the operations of claim 1.

12. The apparatus of claim 11, wherein said instructions include further instructions capable of directing the machine to perform the operations of claim 4.

13. The apparatus of claim 12, wherein said instructions include further instructions capable of directing the machine to perform the operations of claim 5.

14. The apparatus of claim 11, wherein said instructions include further instructions capable of directing the machine to perform the operations of claim 6.

15. The apparatus of claim 11, wherein said instructions include further instructions capable of directing the machine to perform the operations of claim 7.

16. The apparatus of claim 15, wherein said instructions include further instructions capable of directing the machine to perform the operations of claim 8.

17. The apparatus of claim 15, wherein said instructions include further instructions capable of directing the machine to perform the operations of claim 7.

18. A system, comprising:
a system at a first location having disposed therein a content formatting server, and a handheld device communicatively coupled to the content formatting server;
a first memory accessible by the handheld device having first instructions stored therein, which when executed by the handheld device, direct the handheld device to monitor a user interface for a trigger event, and responsive thereto, to request a catalog from the content formatting server;
a system at a second location, different from said first location, having disposed therein a content initiator communicatively coupled to the content formatting server; and
a second memory accessible by the content formatting server having second instructions stored therein, which when executed by the formatting server, direct the content formatting server to retrieve the catalog from the content initiator in a first data format, and provide the catalog to the handheld device in a second format.

19. The system of claim 18, wherein the first data format is the same as the second format.

20. The system of claim 18, wherein said second instructions include further instructions for converting the first data format into the second data format.

21. The system of claim 18, further comprising:
a content provider communicatively coupled to the formatting server;
wherein said first instructions include further instructions, which when executed by the handheld device, direct the handheld device to retrieve content from the content provider.

22. The system of claim 21, wherein said instructions include further instructions, which when executed by the handheld device, direct the handheld device to:
display the catalog on the handheld device;
receive a selection of a catalog entry corresponding to content provided by a content provider; and
retrieve said content from the content provider.
